(19) United States
(12) Patent Application Publication
(10) Pub. No.: US 2020/0257954 A1
(43) Pub. Date: Aug. 13, 2020

(54) TECHNIQUES FOR GENERATING DIGITAL PERSONAS

(71) Applicant: Rival Theory, Inc., Los Angeles, CA (US)

(72) Inventors: William Klein, Los Angeles, CA (US); Amanda Solosky, Los Angeles, CA (US); Glenn Huval, Los Angeles, CA (US); Tyler Payne, Los Angeles, CA (US)

(73) Assignee: Rival Theory, Inc., Los Angeles, CA (US)

(21) Appl. No.: 16/788,005

(22) Filed: Feb. 11, 2020

Related U.S. Application Data
(60) Provisional application No. 62/804,026, filed on Feb. 11, 2019.

(51) Int. Cl. G06N 3/00; G06N 5/02; G06N 20/00; G06N 5/04

(52) U.S. Cl. CPC G06N 3/004; G06N 5/04; G06N 20/00; G06N 5/02

(57) ABSTRACT

A system for determining autonomous actions of a digital persona includes a desire subsystem configured to identify a desire of the digital persona based upon a priority value of the desire determined using a state of the digital persona, and an intent subsystem configured to select a subset of intents with outcomes that are predicted to reduce the priority value of the desire. The system also includes a goal-setting subsystem configured to map the subset of intents to one or more goals with outcomes matching the outcomes of the subset of intents, a planning subsystem configured to determine a set of plan elements for achieving the one or more goals, an action subsystem configured to initiate or perform the set of plan elements, and a sensory subsystem configured to receive feedback and update the state associated with the digital persona.

### CROSS-REFERENCE TO RELATED APPLICATION

This patent application claims benefit of and priority to U.S. Provisional Patent Application Ser. No. 62/804,026, filed Feb. 11, 2019, entitled “Techniques for Generating Digital Personas,” which is assigned to the assignee hereof and is hereby incorporated by reference in its entirety for all purposes.

### BACKGROUND

Artificial intelligence solutions are being developed to perform certain tasks that humans excel at, such as object detection, face recognition, driving, language translation, answering questions, and the like. However, these artificial intelligence solutions are generally task-oriented solutions for solving specific problems. Even though some of these artificial intelligence solutions may, in some cases, provide certain levels of interactivity, they may not be able to engage in deep, human-like interactions, much less performing many mental and/or physical activities that real people can do.

### SUMMARY

The present disclosure relates generally to techniques for generating digital personas. More specifically, disclosed herein are techniques for generating digital personas that can perform human-like interactions and other activities that require human-like thought processes. Various inventive embodiments are described herein, including methods, systems, non-transitory computer-readable storage media storing programs, code, or instructions executable by one or more processors, and the like.

According to some embodiments, a system for determining autonomous actions of a digital persona for a subject may include a desire subsystem configured to identify a desire of the digital persona based upon a priority value of the desire determined using a state associated with the digital persona. The system may also include an intent subsystem configured to select, from a set of intents and based upon outcomes associated with the set of intents, a subset of intents with outcomes that are predicted to reduce the priority value of the desire. The system may further include a goal-setting subsystem configured to map the subset of intents to one or more goals with outcomes matching the outcomes of the subset of intents, a planning subsystem configured to determine a set of plan elements for achieving the one or more goals, an action subsystem configured to initiate or perform the set of plan elements, and a sensory subsystem configured to receive feedback and update the state associated with the digital persona.

In some embodiments, the system may include a memory subsystem. The memory subsystem may store at least one of the state associated with the digital persona, the set of intents and the outcomes associated with the set of intents, the one or more goals and the outcomes of the one or more goals, data used to determine the priority value of the desire, a plan including the set of plan elements and data used to perform the set of plan elements, data associated with the subject, or general or expert knowledge not specific to the subject.

In some embodiments, the desire subsystem may include a set of functions configured to calculate priority values of a plurality of desires based upon the state associated with the digital persona. The state associated with the digital persona may include at least one of an internal state of the digital persona or an external state of an external environment of the digital persona. The external state may include, for example, an external stimulus detected by the sensory subsystem.

In some embodiments, the set of plan elements may include at least one of an operator configured to change the internal state but not the external state, an action for conveying a visual, audio, text, or electronic message to the external environment of the digital persona, a goal, or a behavior including at least one of an operator, an action, or a goal. Each plan element in the actions, goals, and behaviors may be associated with at least one of a pre-condition to be met before performing the plan element, a post-condition resultant from the performing the plan element, or a condition to be maintained during the performing the plan element. The planning subsystem may also determine data used to perform the set of plan elements.

In some embodiments, the intent subsystem may include a machine-learning model configured to select the subset of intents based upon the outcomes associated with the set of intents and effects of the outcomes associated with the set of intents on the state of the digital persona. Each intent in the set of intents is associated with one or more outcomes. Each goal of the one or more goals may also include a method for achieving one or more outcomes.

According to certain embodiments, a non-transitory computer-readable storage medium may store computer-executable instructions that, when executed by one or more processors of a computing system, cause the one or more processors to perform operations. The operations may include identifying a desire of a digital persona for a subject based upon a priority value of the desire determined using a state associated with the digital persona; selecting, from a set of intents and based upon outcomes associated with the set of intents, a subset of intents with outcomes that are determined to reduce the priority value of the desire; mapping the subset of intents to one or more goals with outcomes matching the outcomes of the subset of intents; determining a set of plan elements for achieving the one or more goals; initiating or performing the set of plan elements; receiving feedback; and updating the state associated with the digital persona.

In some embodiments, determining the set of plan elements may also include determining data used to perform the set of plan elements. The set of plan elements may include at least one of an operator for changing an internal state but not an external state of the digital persona, an action for conveying a visual, audio, text, or electronic message to the external environment of the digital persona, a goal, or a behavior including at least one of an operator, an action, or a goal. Each plan element in the actions, goals, and behaviors may be associated with at least one of a pre-condition to be met before performing the plan element, a post-condition resultant from the performing the plan element, or a condition to be maintained during the performing the plan element.

According to certain embodiments, a computer system may include one or more processors, and a non-transitory computer readable storage medium containing instructions. The instructions, when executed by the one or more processors, may cause the one or more processors to perform operations. The operations may include identifying a desire of a digital persona for a subject based upon a priority value of the desire determined using a state associated with the digital persona; selecting, from a set of intents and based upon outcomes associated with the set of intents, a subset of intents with outcomes that are determined to reduce the priority value of the desire; mapping the subset of intents to one or more goals with outcomes matching the outcomes of the subset of intents; determining a set of plan elements for achieving the one or more goals; initiating or performing the set of plan elements; receiving feedback; and updating the state associated with the digital persona.

In some embodiments, the computer system may include a memory subsystem. The memory subsystem may store at least one of the state associated with the digital persona, the set of intents and the outcomes associated with the set of intents, the one or more goals and the outcomes of the one or more goals, data used to determine the priority value of the desire, a plan including the set of plan elements and data used to perform the set of plan elements, data associated with the subject, or general or expert knowledge not specific to the subject.

In some embodiments of the computer system, the set of plan elements may include at least one of an operator for changing an internal state but not an external state of the digital persona, an action for conveying a visual, audio, text, or electronic message to the external environment of the digital persona, a goal, or a behavior including at least one of an operator, an action, or a goal. Each plan element in the actions, goals, and behaviors may be associated with at least one of a pre-condition to be met before performing the plan element, a post-condition resultant from the performing the plan element, or a condition to be maintained during the performing the plan element. Each intent in the set of intents may be associated with one or more outcomes. Each goal of the one or more goals may include a method for achieving one or more outcomes.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1 is a flowchart illustrating an example of a process of implementing a digital persona for a subject according to certain embodiments.

FIG. 2 illustrates an example of a digital persona system for implementing a digital persona according to certain embodiments.

FIG. 3 illustrates an example of a knowledge element in a knowledge database of a digital persona according to certain embodiments.

FIG. 4 illustrates an example of a series of beliefs according to certain embodiments.

FIG. 5 illustrates an example of a cognitive chain for implementing a digital persona according to certain embodiments.

FIG. 6A illustrates an example of a desire layer for determining desires in a digital persona system according to certain embodiments. FIG. 6B illustrates an example of a function used in the desire layer for determining desires according to certain embodiments. FIG. 6C illustrates another example of a function used in the desire layer for determining desires according to certain embodiments.

FIG. 7 illustrates an example of an intent layer for determining intents based on desires in a digital persona system according to certain embodiments.

FIG. 8A illustrates an example of an intent of a digital persona according to certain embodiments. FIG. 8B illustrates an example of mapping active intents to goals according to certain embodiments.

FIG. 9A illustrates an example of a plan element of a digital persona according to certain embodiments. FIG. 9B illustrates an example of a plan that includes a set of plan elements determined by a planner to achieve a target state of the digital persona according to certain embodiments.

FIG. 10 illustrates an example of a performing subsystem for implementing a digital persona of a subject according to certain embodiments.

FIG. 11 illustrates an example of an audio wave from an audio recording of a speech or conversation of a subject and the corresponding transcript for training an audio synthesis model according to certain embodiments.

FIG. 12 illustrates an example of a computing system for implementing some embodiments.

### DETAILED DESCRIPTION

The present disclosure relates generally to techniques for generating digital personas. More specifically, disclosed herein are techniques for generating digital personas that can perform human-like activities. A real, physical person can only be present in a specific physical location at a given time. Thus, it may often be expensive or difficult for a single person to have one-to-one or in-person interactions with a popular person, such as a public figure or a representative of an organization, and it would be impossible for millions of people to do so. In addition, a person may not live forever and thus may not always be available for in-person interactions, or a person may be fictional and may never be available for in-person interactions. Task-oriented artificial intelligence solutions may perform with certain levels of interactivity, but may not be able to engage in true human-like interactions. For example, most task-oriented artificial intelligence solutions may not interact through a knowledge-based model of who the audience is and thus could not form personal relationship with the audience to engage in bi-directional and personal interactions.

According to certain embodiments, an entity-based digital persona system capable of learning from data associated with a real person and performing human-like activities is disclosed. The digital persona system may be based on a knowledge database and a cognitive subsystem. The digital persona system may implement one or more digital personas that have the knowledge, experience, personal relationship, behavioral manners, beliefs, opinions, appearance, and the like of a real person, based on the knowledge database. The digital persona can be instantiated in many instances to perform a set of cognitive processes and actions as the real person. The digital persona system may use various data associated with the real person, such as audio, video, and text data, to generate and update the knowledge database. The digital persona can have a persistent existence and can be maintained and updated over time to more accurately model the real person and to grow like a real person, such as gaining new knowledge, learning new skills, building new relations with other peoples, forming new beliefs and viewpoints, and the like. Various inventive embodiments are described herein, including methods, systems, non-transitory computer-readable storage media storing programs, code, or instructions executable by one or more processors, and the like.

According to certain embodiments, a system for determining autonomous actions of a digital persona for a subject may include a desire subsystem configured to identify a desire of the digital persona based upon a priority value of the desire determined using a state associated with the digital persona. The system may also include an intent subsystem configured to select, from a set of intents and based upon outcomes associated with the set of intents, a subset of intents with outcomes that are predicted to reduce the priority value of the desire. The system may further include a goal-setting subsystem configured to map the subset of intents to one or more goals with outcomes matching the outcomes of the subset of intents, a planning subsystem configured to determine a set of plan elements for achieving the one or more goals, an action subsystem configured to initiate or perform the set of plan elements, and a sensory subsystem configured to receive feedback and update the state associated with the digital persona.

In some embodiments, the system may include a memory subsystem. The memory subsystem may store at least one of the state associated with the digital persona, the set of intents and the outcomes associated with the set of intents, the one or more goals and the outcomes of the one or more goals, data used to determine the priority value of the desire, a plan including the set of plan elements and data used to perform the set of plan elements, data associated with the subject, or general or expert knowledge not specific to the subject.

An entity-based digital persona generated using techniques disclosed herein can have its unique identification and can have personal relationship with individual persons, and thus can have bi-directional human-like interactions with individual persons. Techniques disclosed herein can be used to generate digital personas for public figures, domain experts, or other popular individuals such that they can be instantiated in as many instances as possible to “personally” interact with many people at any given time. Techniques disclosed herein can also be used to generate and implement digital personas for any person that wishes to achieve digital eternity or digital immortality such that their personas can interact with their relatives, friends, or descendants beyond their biological lives. In some embodiments, techniques disclosed herein can be used to create and implement digital personas for actors, actresses, or other performers to perform without their physical presence, thus extending their reach, career, and influence, even beyond their biological lives. In some embodiments, techniques disclosed herein can be used to personify a fictional person, thus supporting personal interactions as if the fictional person were real. In some embodiments, techniques disclosed herein can be used to personify a brand, thus bringing the brand to life and enabling deep one-to-one customer relationship.

As used herein, a “digital persona” or a “digital agent” for a subject may refer to a computer program capable of carrying out intentional functions through both autonomous and reactive behaviors based on internal models and interactions with its environment. A “desire” may refer to a motivating factor that does not necessarily require a logical pre-motivation. An “intent” may refer to a desired outcome that may satisfy one or more desires. A “goal” may refer to a measurable desired outcome that may be decomposed into sub-goals and/or may be achieved through actions. A “plan” may refer to a sequence of steps, including actions, operators, behaviors, and goals intended to achieve one or more desired outcomes. An “action” may refer to an activity, either atomic or continuous, that changes the internal state of the digital persona or the external state of the environment. An “operator” may refer to a transformational action that changes the internal state of the digital persona. A “behavior” may refer to a predefined set of facts, operators, goals, and actions that may be treated by the planner as a single step. A “state” of a digital persona may refer to the composition of all factors, including memory, stored numeric values, logical assertions, and other elements that collectively produce the behavior of the agent at any point in time. An “external state” may refer to the properties of the environment, both physical and digital, outside the digital persona. An “internal state” may refer to factors of the state of digital persona other than the properties of the environment.

In the following description, for the purposes of explanation, specific details are set forth in order to provide a thorough understanding of examples of the disclosure. However, it will be apparent that various examples may be practiced without these specific details. The ensuing description provides examples only, and is not intended to limit the scope, applicability, or configuration of the disclosure. Rather, the ensuing description of the examples will provide those skilled in the art with an enabling description for implementing an example. It should be understood that various changes may be made in the function and arrangement of elements without departing from the spirit and scope of the disclosure as set forth in the appended claims. The figures and description are not intended to be restrictive. Circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples. The teachings disclosed herein can also be applied to various types of applications such as mobile applications, non-mobile application, desktop applications, web applications, enterprise applications, and the like. Further, the teachings of this disclosure are not restricted to a particular operating environment (e.g., operating systems, devices, platforms, and the like) but instead can be applied to multiple different operating environments.

Also, it is noted that individual examples may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function. The word “example” or “exemplary” is used herein to mean “serving as an example, instance, or illustration.” Any embodiment or design described herein as “exemplary” or “example” is not necessarily to be construed as preferred or advantageous over other embodiments or designs.

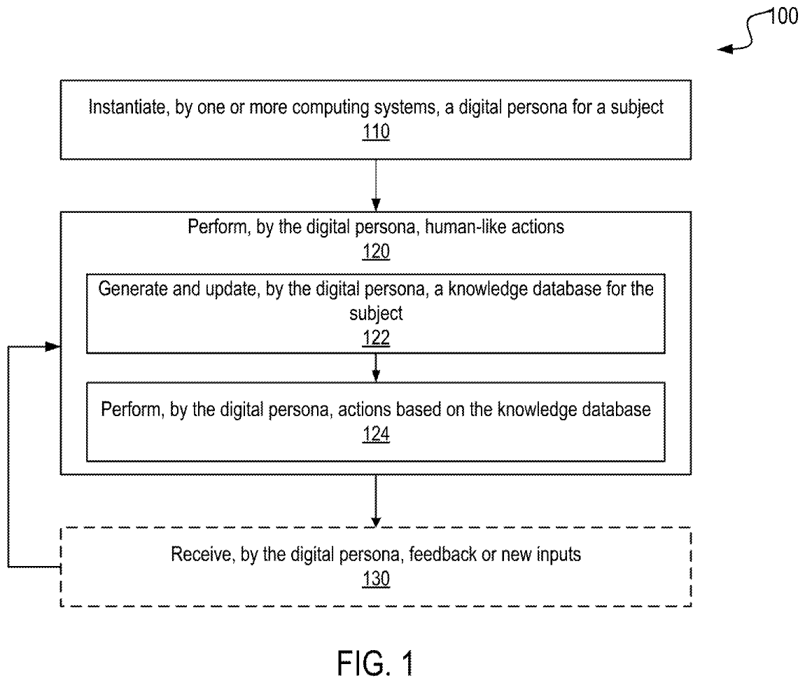

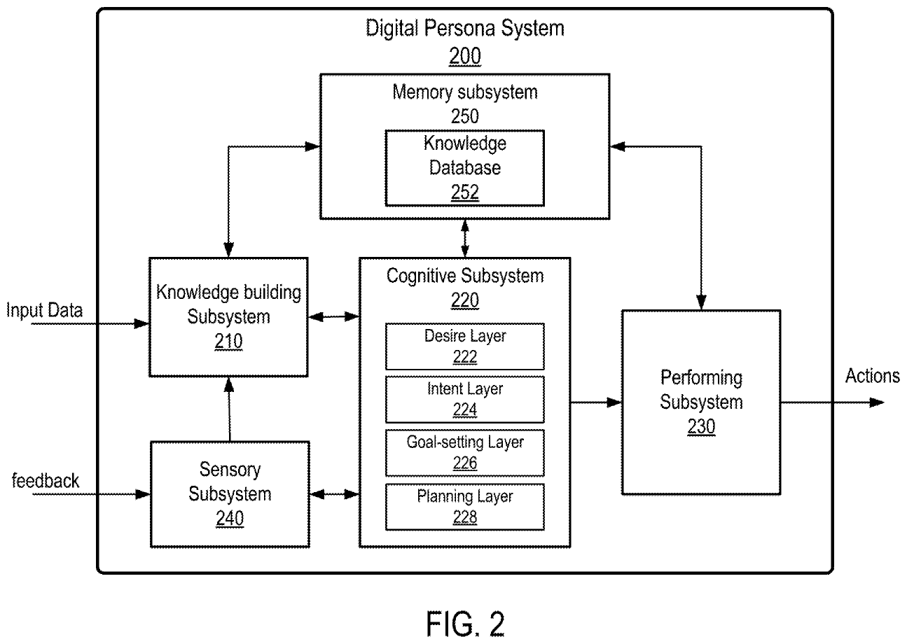

FIG. 1 is a simplified flowchart 100 illustrating an example of a process of implementing a digital persona for a subject according to certain embodiments. The operations in flowchart 100 can be performed by one or more computing systems, such as mobile devices, personal computers, servers, or a cloud computing system. At 110, the one or more computing systems may instantiate a digital persona for a subject. For example, the one or more computing system may implement a digital persona system. The digital persona system may include hardware resources, such as processing units, memory devices, input devices (e.g., sensors), and output devices (e.g., text, audio, or video output devices). The digital persona system may also include code and data stored in the memory devices. The code and data may be executed or used by the hardware resource to implement the digital persona. The code may be used to perform, for example, rule-based or machine-learning-based functions, such as a cognitive subsystem, a knowledge building subsystem, a performance subsystem, a knowledge database, and the like. More details of the digital persona system are described below, for example, with respect to FIG. 2.

In some embodiments, a knowledge database may be created for the digital persona when the digital persona is instantiated, where the knowledge database may or may not include subject-specific knowledge. In some embodiments, the knowledge database for the initiated digital persona may include some common knowledge that may not be specific to the subject. For example, the knowledge database may include certain knowledge for implementing the digital persona, such as algorithms, machine-learning models, rules, code, and the like. In some embodiments, the knowledge database for the initiated digital persona may include some information regarding the subject, such as the identification of the subject and some knowledge that the subject may possess. In some embodiments, the knowledge database for the initiated digital persona may not include any data specific to the subject, where subject-specific data may need to be gradually learned over time by the digital persona system (more specifically, the knowledge building subsystem) to enrich or update the knowledge database.

Once instantiated, the digital persona may acquire source data related to the subject, including both general knowledge and expert knowledge known by other humans, extract and learn information related to the subject (e.g., knowledge, skills, behavioral manners possessed by the subject, which may be collectively referred to as human knowledge herein) from the acquired source data, and perform certain human-like activities, such as thinking and interacting with other people. Many instances of the digital persona may be instantiated at the same time.

At 120, the digital persona may perform human-like activities. For example, the digital persona may acquire new knowledge or perform other human-like activities, such as learning, thinking, and interacting with other people. For example, at 122, the digital persona may learn new knowledge to enrich or update the knowledge database for the subject or to expand the subject's capabilities. The knowledge database may in turn be used by the digital persona to perform other human-like activities. The new knowledge may be acquired from various forms of source data associated with the subject. The source data may include, for example, video recordings, audio recordings, and text messages associated with the subject, interactions of the subject with other people, and the like. Knowledge may be extracted from the source data and saved in the knowledge database. For example, the source data may be converted into text, either directly from books, transcripts, or other written materials, or indirectly from audio and visual information that may be translated or transcribed into text descriptions. Knowledge may then be extracted from the source data represented as text and may be saved in appropriate formats and structures in the knowledge database. The knowledge database may include, for example, various factual information and behavior information regarding the subject. The factual information can include, for example, the identification, appearance, personality, emotion, knowledge, history, beliefs, relationship, and the like, of the subject. The behavior information may include, for example, the manners in which the subject thinks, learns, speaks, acts, sings, and the like.

At 124, the digital persona may perform human-like actions, such as thinking, speaking, acting, or the like, based on the knowledge database. For example, the digital persona may implement a cognitive subsystem that can convert higher level desires or goals to lower level actions that can be performed by a performance subsystem. In some embodiments, the digital persona may, without receiving external stimuli, take actions autonomously based on certain internal states. In some embodiments, the digital persona may receive a stimulus from a sensor (such as a camera or a microphone) or other input devices, communication devices, or detectors, and determine the actions to take in response to the stimulus. For example, the digital persona may receive an input, such as a greeting or a question from a real person, a scheduler, or a sensor output. In response to the input or spontaneously, the digital persona may take a set of cognitive processes based on the information in the knowledge database and certain contextual information to determine one or more internal operators or external actions to take. The internal operators may include, for example, updating knowledge in the knowledge database. The external actions may include, for example, conveying certain information (e.g., video, audio, or text message) to the real person in response to the utterance from the real person. The digital persona may also determine the manners in which the subject would convey the information. The digital persona may, through a performance subsystem, convey the message in the determined manners to an audience, such as synthesizing audio output (e.g., in a determined tone, volume, age, etc.) and/or rendering visual outputs (e.g., body movements or face expressions) through one or more user interface devices, such as a speaker, a display, or a projector.

At 130, the digital persona may receive feedback from the external environment (e.g., an audience) through physical or virtual sensors that can capture visual or audio information. Based on the feedback, the digital persona may determine subsequent internal operators or external actions to take. For example, the digital persona may continue to interact with the real person, may adjust the information to convey, or may determine that a goal has been achieved and then move on to the next goal. In some embodiments, the digital persona may update the knowledge database based on the feedback, such as adding or updating the knowledge, experience, or beliefs of the digital persona. In some embodiments, the digital persona may receive new source data, such as new video recordings, audio recordings, and text (e.g., books, transcripts, or other written materials), extract new knowledge from the new source data, and save the new knowledge in the knowledge database. In this way, the digital persona may continue to learn and develop from its interactions with the external world.

FIG. 2 illustrates an example of digital persona system 200 for implementing a digital persona of a subject according to certain embodiments. Digital persona system 200 may include a knowledge building subsystem 210, a cognitive subsystem 220, a performing subsystem 230, a sensory subsystem 240, and a memory subsystem 250. Digital persona system 200 may be implemented on one or more computers, mobile devices, handheld devices, servers, or a cloud computing environment. Digital persona system 200 may be used to implement an instance of a digital persona that can act spontaneously or react to some inputs, such as upon detection of a person or a sound signal, or upon receiving a stimulus that may include a high-level plot or goal. Digital persona system 200 may implement the digital persona based on knowledge associated with the subject stored in memory subsystem 250, rather than using codes or instructions programmed to perform specific functions (e.g., acting according to pre-determined plots or scripts).

Knowledge building subsystem 210 may receive input data (e.g., video, audio, or text input data) from one or more communication devices (e.g., wired or wireless communication devices) or other input devices (e.g., keyboard, disk drive, scanner, etc.). In some embodiments, knowledge building subsystem 210 may also receive input data from sensory subsystem 240 that may include, for example, a camera, a microphone, and the like. Knowledge building subsystem 210 may receive input data regarding a subject, such as knowledge data, behavior data, image or video data, audio data, and/or text information associated with the subject, and build a knowledge database 252 for the subject. Knowledge building subsystem 210 may perform various input data processing and knowledge extraction. For example, knowledge building subsystem 210 may convert video data or audio data into text data, parse the text data, extract knowledge elements from the text data, represent the knowledge elements using appropriate structures, and save the representation structures in knowledge database 252. Knowledge database 252 may be saved in memory subsystem 250. Knowledge database 252 may include, for example, factual information, understanding, and belief; internal state of the digital persona; processes for acquiring the factual information, understanding, and belief; processes for thinking and making decisions; processes for rendering the audio and visual outputs in a manner that the subject may behave, and the like.

Memory subsystem 250 may include one or more local or remote storage devices. For example, in some embodiments, memory subsystem 250 may include a remote memory device on a server or a cloud. In some embodiments, memory subsystem 250 may be distributed across different cloud storage or other storage devices. In some embodiments, memory subsystem 250 may be partially available, where only portions of the memory subsystem 250 that store data relevant to current processing and interaction must be made available to the digital persona, while other latent memory may be distributed across local, remote, or cloud storage or may be in disconnected storage devices.

Memory subsystem 250 stores the knowledge database for the digital persona, including both common knowledge and subject-specific knowledge. For example, the knowledge database may include certain knowledge for implementing the digital persona, such as algorithms, machine-learning models, rules, code, and the like. The knowledge database may also include subject-specific knowledge, such as various factual information and behavior information regarding the subject as described above. In some embodiments, knowledge building subsystem 210 may acquire new knowledge and store the new knowledge in the knowledge database in memory subsystem 250. In some embodiments, cognitive subsystem 220 may also generate or update knowledge and save it in memory subsystem 250. Thus, the knowledge database may be updated based on the interactions between the digital persona and external environment, such as the audience. Memory subsystem 250 may be accessible by other subsystems of digital persona system 200 for reading or writing knowledge elements from or into knowledge database 252.

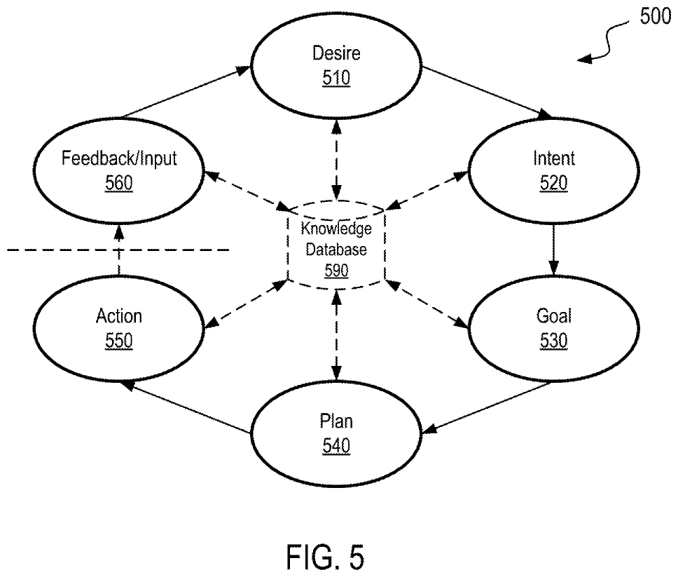

Cognitive subsystem 220 may determine a high-level motivation or a goal to accomplish based on recent knowledge, internal states, or external inputs. Based on the high-level motivation or goal, cognitive subsystem 220 may determine the internal operators and/or external actions to take, such as determining the content of information to convey to a person or an audience and conveying the information in an appropriate manner, using the knowledge in the knowledge database 252 for the digital persona save in memory subsystem 250. For example, cognitive subsystem 220 may implement a cognitive chain to think and act. In some embodiments, the cognitive chain may begin with a desire layer 222 that may determine a set of desires based on the internal state of and/or external inputs to the digital persona. An intent layer 224 may map the set of desires to a set intents. A goal-setting layer 226 may map the set of intents to goals that may match the desired outcomes of the intents. A planning layer 228 may link the desired outcomes to a set of known plan elements (e.g., behaviors, operators, goals, or actions) for the digital persona to accomplish the desired outcomes. More details of cognitive subsystem 220 are described below, for example, with respect to FIG. 5.

Performing subsystem 230 may carry out the set of plan elements. In some embodiments, the plan elements may include actions that may change the external state or appearance of the digital persona, such as conveying certain information to a real person or audience using an audio synthesis model or visual models associated with the digital persona. For example, in some embodiments, performing subsystem 230 may synthesize an audio output using the audio synthesis model, determine the facial and body movements associated with the audio output, transform a 3-D model of the subject based on the determined facial and/or body movements using the visual models, and synchronously render the audio and video outputs through one or more input devices, such as speakers, displays, or projectors. In some embodiments, more than one action may be performed simultaneously by the digital persona.

During or after each action, digital persona system 200 may receive feedback from the external world through sensory subsystem 240. Sensory subsystem 240 may, for example, detect the reactions of real peoples or the audience to the audio or video outputs. Sensory subsystem 240 may include one or more physical or virtual sensors that can detect the reactions of the audience. Sensory subsystem 240 may feed the detected reactions of the audience to knowledge building subsystem 210 and/or cognitive subsystem 220, such that digital persona system 200 may respond to the feedback accordingly. For example, the feedback received by sensory subsystem 240 may be processed by the knowledge building subsystem 210 to extract knowledge, update internal state of the digital persona, or add or update other information in knowledge database. The feedback may indicate whether a desire or goal has been achieved, and the internal state may be updated accordingly. Cognitive subsystem 220 may then start the cognitive chain again based on the updated internal state as described above. In one example, sensory subsystem 240 may include a physical camera or a virtual camera at the location of the digital persona's eye to capture the real person's face, such that performing subsystem 230 may adjust the position of the digital persona to make eye contact with the real person. Cognitive subsystem 220 may execute the cognitive chain continuously, such that the digital persona may continuously learn, think, and act like a real person.

In order to implement a digital persona for a subject, human knowledge for the person needs to be modeled. Various representation techniques may be used to model knowledge, which may or may not be suitable for modeling human knowledge. For example, relational databases use tabular data, in which the columns may represent the “relation” between the table and the data stored within it. These columns are predefined based on an a priori model of the data being represented. Another way to represent broad knowledge is through a network of nodes linked by labeled relations, sometimes referred to as a semantic network, such as a knowledge graph that can be used to represent conceptual data and support and answer web queries. Some of these representation techniques may not be able to adequately represent information that does not adhere to predefined relations, categories, and properties.

According to certain embodiments, symbolic representations may be used to represent human knowledge in, for example, mathematics, philosophy, computer science, and any other fields. The symbolic representations can model any individual piece of knowledge (which is referred to as a knowledge element), regardless of its complexity. The symbolic representations are also able to adapt to new information as it is provided, rather than limited to an a priori set of symbols. The symbolic representations are able to model both static knowledge (e.g., facts) and procedural knowledge (e.g., algorithms). The definition of any knowledge element may be determined by its relations to other knowledge elements within the system, where the relations between knowledge elements may also be knowledge elements within the knowledge database.

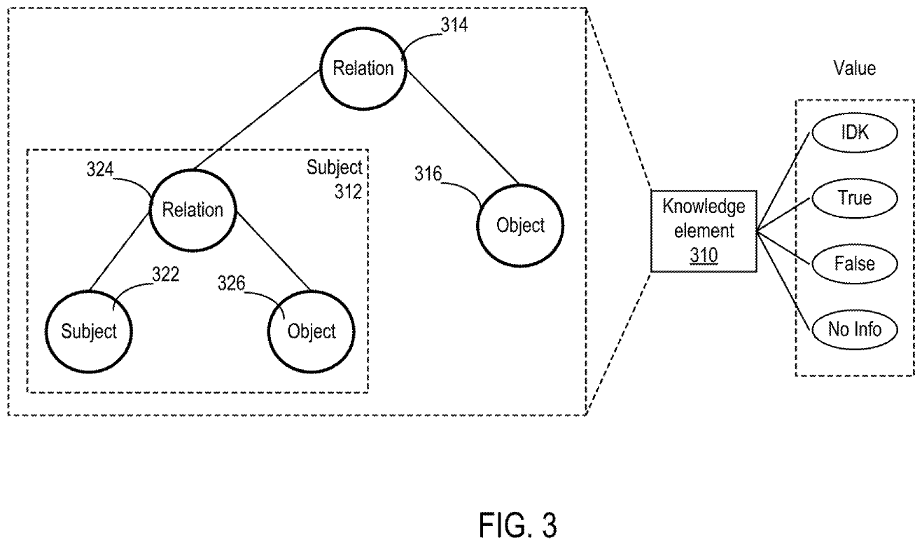

FIG. 3 illustrates an example of a knowledge element 310 in a knowledge database of a digital persona according to certain embodiments. Knowledge element 310 may represent a piece of knowledge that may be stored in the knowledge database, such as knowledge database 252. Knowledge elements may describe the subject's knowledge, experience, beliefs, opinions, skills, manners of thinking, and the like. Knowledge elements can include, for example, events, contexts, timing, procedures, and the like. Knowledge elements may have different values in different contexts. Knowledge elements can be nested and may be interconnected based on their relationships.

In the example shown in FIG. 3, knowledge element 310 may include a subject 312, an object 316, and a relation 314, where relation 314 may describe the relationship between subject 312 and object 316. Each of subject 312, object 316, and relation 314 can also be a knowledge element. For example, as shown in FIG. 3, subject 312 can be a knowledge element that includes a subject 322, an object 326, and a relation 324 that describes the relationship between subject 322 and object 326. Each of subject 322, object 326, and relation 324 can also be a knowledge element.

Knowledge element 310 may have different possible associated values, such as true, false, “I don't know” (“IDK”), or “not enough information” (“No Info”), in different contexts. A knowledge element that has a particular value in a particular context may be referred to as a belief. A digital persona may have a particular belief in a given context or at a given time, and may change its belief over time. A digital persona may have conflicting beliefs among multiple contexts at a given time. In some embodiments, knowledge elements (and the corresponding beliefs) acquired at different times may be represented by a series of beliefs.

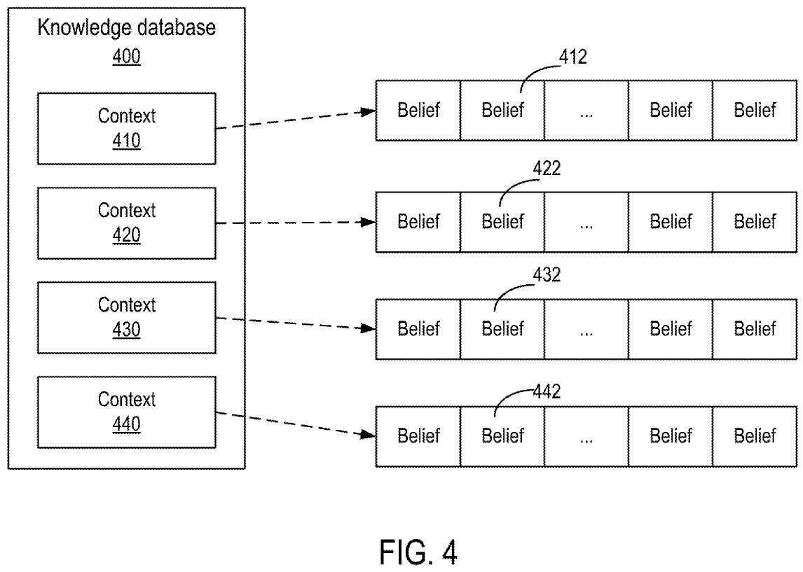

FIG. 4 illustrates examples of contexts each including a series of beliefs in a knowledge database 400 associated with a digital persona according to certain embodiments. Knowledge database 400 shown in FIG. 4 may be a portion or an example of knowledge database 252 described above. Knowledge database 400 may include a plurality of contexts 410, 420, 430, 440, and the like. The plurality of contexts shown in FIG. 4 may be contexts that are relevant to current processing and interaction. Other contexts that may not be relevant to the current processing and interaction may be stored in other portions of knowledge database 252 or memory subsystem 250.

As illustrated, each context of the plurality of contexts may include a series of beliefs, such as beliefs 412, 422, 432, 442, and the like. Each belief in the series of beliefs in a context may correspond to a value of a knowledge element or a state of the digital persona in the particular context. The value of a knowledge element may change when the context changes. A context may be, for example, a global context, a historical context, a recent context, or a current context (which may become recent context or historical context at a later time). In some embodiments, a belief may be an assumption and may be invalidated later if it contradicts some other beliefs. In some embodiments, the digital persona may be self-reflective, where a change in the value of a knowledge element in a context (i.e., a belief) may cause the re-evaluation of other knowledge elements at a later time and thus may cause changes of some beliefs.

Knowledge elements may be generated in many different ways. Some knowledge elements may be generated from input data. For example, individual words in an input sentence (e.g., in written text or transcript of an audio) may be represented by knowledge elements, the meaning of an individual word may be represented by a knowledge element, and the relation between an individual word and the corresponding meaning of the individual word may also be represented by a knowledge element. In some embodiments, semantic analysis may be used to generate knowledge elements and relations between knowledge elements. In some embodiments, statistical analysis may be used to analyze the use of words in text, where each word may associate with a vector and each value in the vector may represent a feature of the word. The meaning of a word may be represented or indicated by the features in the vector. Each word can be mapped to a multi-dimensional space, where each feature may correspond to one dimension. Words that are close to each other in the multi-dimensional space may have the same or similar meanings. Relationship between two words may be determined by the relative locations or distance between the data points representing the two words in the multi-dimensional space, which may be represented by some mathematical equations or operations. For example, the word “king” may include a value “male” for the gender feature and values for other features, and the word “queen” may include a value “female” for the gender feature and values for other features. Subtracting “male” in the gender feature from and adding “female” in the gender feature to the vector for “king” may result in the vector for “queen.”

In some embodiments, additional knowledge elements may be generated based on the knowledge elements generated from input data. For example, a new knowledge element may be generated from an existing knowledge element by applying another knowledge element to the existing knowledge element. In some embodiments, knowledge elements may also be generated based on certain causal relations. For example, if one event (e.g., a ball is hit) happens after another event (e.g., a bat is swung), a knowledge element may be generated to represent the causal relation between the two events.

As described above, the digital persona may perform human-like activities using the knowledge database. For example, the cognitive subsystem of the digital persona system may implement a cognitive chain that uses the knowledge in the knowledge database to determine detailed operations or actions for fulfilling a certain desire or achieving a certain goal or of the digital persona.

FIG. 5 illustrates an example of a cognitive chain 500 for implementing a digital persona according to certain embodiments. Cognitive chain 500 may be implemented using a cognitive subsystem (e.g., cognitive subsystem 220 of digital persona system 200) and based on knowledge stored in a knowledge database 590 (e.g., knowledge database 252). Cognitive chain 500 can be executed continuously or until one or more high-level desires or motivations are achieved.

At 510, a desire layer may determine a high-level desire of the digital persona spontaneously based on the internal state of the digital persona, or may determine a high-level desire of the digital persona in response to some stimulus data that may change the internal state of the digital persona. The stimulus data may include, for example, a particular setting or context (e.g., a meeting or a show), the detection of a person who may have some relationship with the subject represented by the digital persona, an audio signal (e.g., a question or a greeting), text information, a high-level topic, script or plot, or the like. The digital persona may understand the stimulus data, update the internal state, and determine the high-level desire (e.g., motivation or problem to solve). In some embodiments, the desire layer may be customized for the subject to reflect the behaviors of the subject. Thus, the desire layer may be different for different digital personas to represent the different behaviors of different subjects.

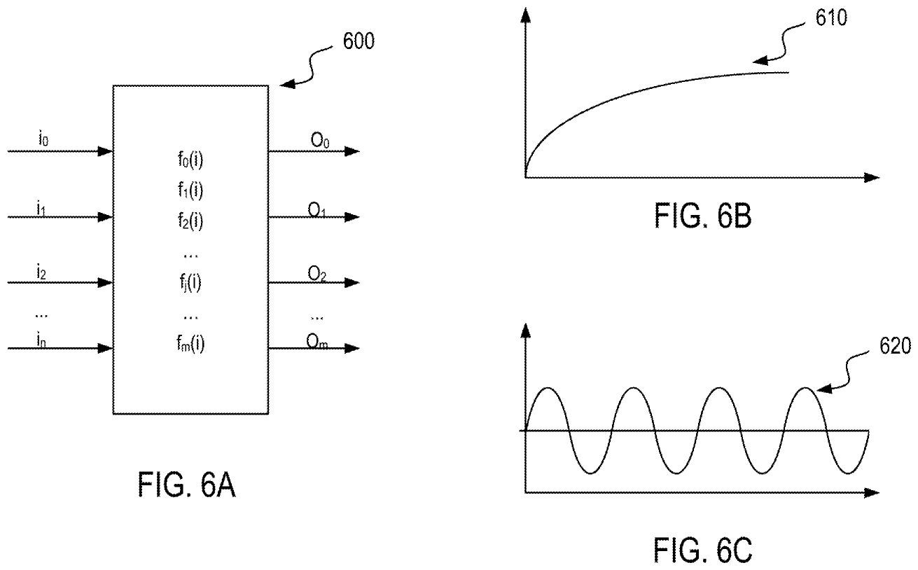

FIG. 6A illustrates an example of a desire layer 600 for determining desires in a digital persona system according to certain embodiments. Desire layer 600 may be a part of a cognitive subsystem (e.g., cognitive subsystem 220) for implementing cognitive chain 500. Desire layer 600 may include a plurality of functions f₀(I), f₁(I), f₂(I), . . . , and fₘ(I). Each function in the plurality of functions may be a function to determine a change in the intensity (or insistence or priority) of a desire. Inputs I to the functions may be numeric values, and outputs O of the functions may also be numeric values. Inputs I may include a plurality of input values i₀, i₁, i₂, . . . , and iₙ. Each input value may include, for example, a time value, a normalized value of a sensor (e.g., the detection of the presence of a human), a normalized value representing the intensity of an internal state of the digital persona (e.g., the remaining energy of an artificial intelligence robot), or any value representing a factor that may impact the intensity of a desire. Outputs O of the functions may include O₀, O₁, O₂, . . . , and Oₘ, which may represent the intensity of each desire. Some of the functions may be functions of time, for example, if any input in inputs I is a time value or a time-dependent value. Outputs O of desire layer 600 may indicate the relative intensity or insistence of active desires. In some embodiments, a neural network, rather than a set of functions, may be used to determine the intensity or insistence of active desires based on inputs I.

FIG. 6B and FIG. 6C illustrate examples of functions used in desire layer 600. FIG. 6B illustrates an example of a function 610 for determining an intensity of a desire. In the example shown in FIG. 6B, function 610 may be a logarithmic function, where the output intensity value may be a logarithmic function of the input value. FIG. 6C illustrates an example of a function 620 for determining an intensity of a desire. In the example shown in FIG. 6C, function 620 may be a sinusoidal function, where the output intensity value may oscillate with the increase of the input value.

Referring back to FIG. 5, at 520, an intent layer may determine one or more intents based on the intensity values of one or more desires determined by the desire layer (e.g., desire layer 600). An intent may be a high level description of things to do (i.e., what does the persona want). In some embodiments, intents may be defined in terms of the future impact they may have on the high-level desires. For example, an intent may be defined based in its outcomes. An intent may have one or more outcomes. The one or more outcomes may change the state of the digital persona, which may in turn change the intensity of a desire. In some embodiments, the intent layer may include one or more machine-learning models, such as a classifier, that may map high-level desires to intents. For example, the machine-learning models may be trained to select intents whose outcomes are predicted to maximally reduce the intensity (or insistence or priority) of an active desire.

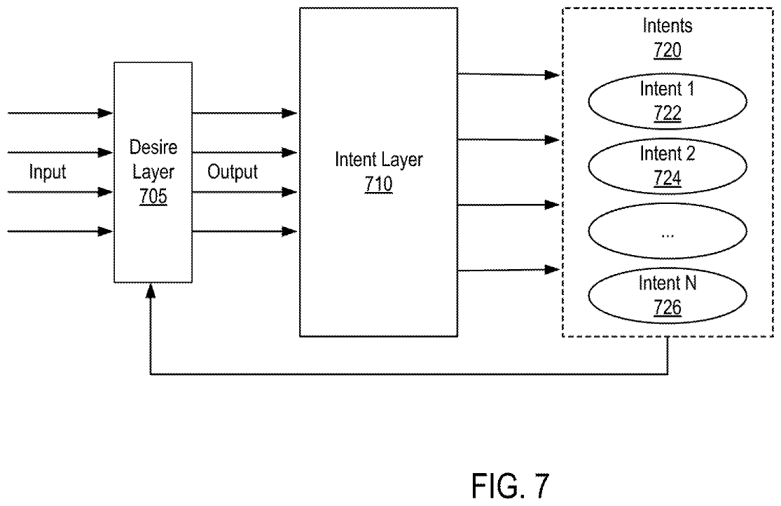

FIG. 7 illustrates an example of an intent layer 710 for determining one or more intents for a digital persona based on one or more desires of the digital persona according to certain embodiments. The input to intent layer 710 may be the outputs of a desire layer 705, such as desire layer 600 described above. The outputs of intent layer 710 may be a subset of intents selected from a set of intents 720 stored in the knowledge database. The selected subset of intents may include intent 1 (722), intent 2 (724), . . . , and intent N (726). The subset of intents may be selected because the outcomes associated with the subset of intents may be determined to be able to maximally reduce the intensity values of the active desires at the outputs of desire layer 705.

In some embodiments, intent layer 710 may include a machine-learning model, such as a classifier implemented using a neural network. As described above, the machine-learning model may be trained to select intents whose outcomes are predicted to change the state of the digital persona in a way that could maximally reduce the intensity values of active desires determined by desire layer 705 as described above.

In some embodiments, intent layer 710 may include a model not based on machine learning. For example, a one-to-one mapping function may be used to map each desire to a single intent, and the intent associated with the highest intensity value may be chosen from a set of intents.

Referring back to FIG. 5, at 530, a goal-setting layer may determine, based on the intents determined at 520, goal(s) to fulfill the intents, such as how to get what the persona wants. For example, if the intent is to teach a class on a topic, the goals may include moving to a location in front of the audience, and then describing the topic. In some embodiments, the goals to fulfill the intents may be determined by matching the outcomes of the goals to the desired outcomes of the intents. Each intent may include one or more outcomes. Each goal may also include one or more outcomes. Intents may differ from goals in that intents may not have pre-conditions.

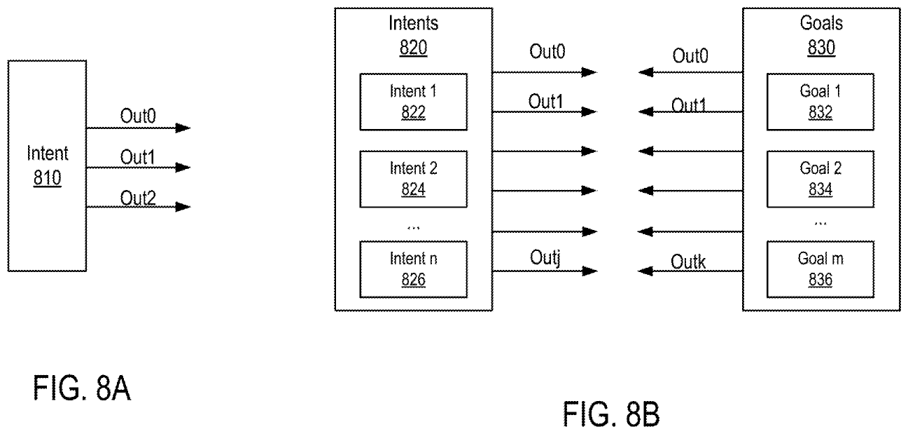

FIG. 8A illustrates an example of an intent 810 according to certain embodiments. Intent 810 may have one or more outcomes Out₀, Out₁, Out₂, and the like. The outcomes can be modeled as logical propositions in a logic-based representation. The outcomes may also be modeled as states in a state or task based representation.

FIG. 8B illustrates an example of mapping active intents 820 to goals 830 according to certain embodiments. The mapping may be based on the outcomes of active intents 820 and goals 830. Active intents 820 may include intent 1 (822), intent 2 (824), . . . , and intent n (826), where each intent may have one or more associated outcomes. The outcomes associated with active intents 820 may include Out0, Out1, . . . , and Outj. A set of goals, including goal 1 (832), goal 2 (834), . . . , and goal m (836), with outcomes matching the outcomes associated with active intents 820 may be selected from goals 830 in a high-level goal library.

At 540, after goals have been identified to resolve the intents, a planning layer may attempt to use the goals to produce plans of internal operators or external actions that may change the internal state or the external state of the digital persona. In some embodiments, the planning layer may select a plan from known plans for each respective goal. In some embodiments, a goal can be accomplished using multiple known plans. In some embodiments, the planning layer may determine a detailed plan that is likely to succeed. The planning layer may determine all operators or actions to take and identify or obtain information for performing the operators or actions. In some embodiments, the external actions may also change the internal state of the digital persona.

The planning layer may include one or more planners. A planner is used to create plans to resolve goals. Various types of planners may be used. The planners may operate on multiple types of plan elements, such as behaviors, operators, goals, actions, and the like. An “operator” may refer to an activity that may change the internal state but not the external state of the digital person. A “goal” may be a description of a desired state. An “action” may refer to a certain mechanism that can change the external state of the digital persona, such as speaking out loud, moving, changing the state of an actuator, and the like. A “behavior” may refer to a predefined set of facts, operators, goals, and actions that may be treated by the planner as a single step.

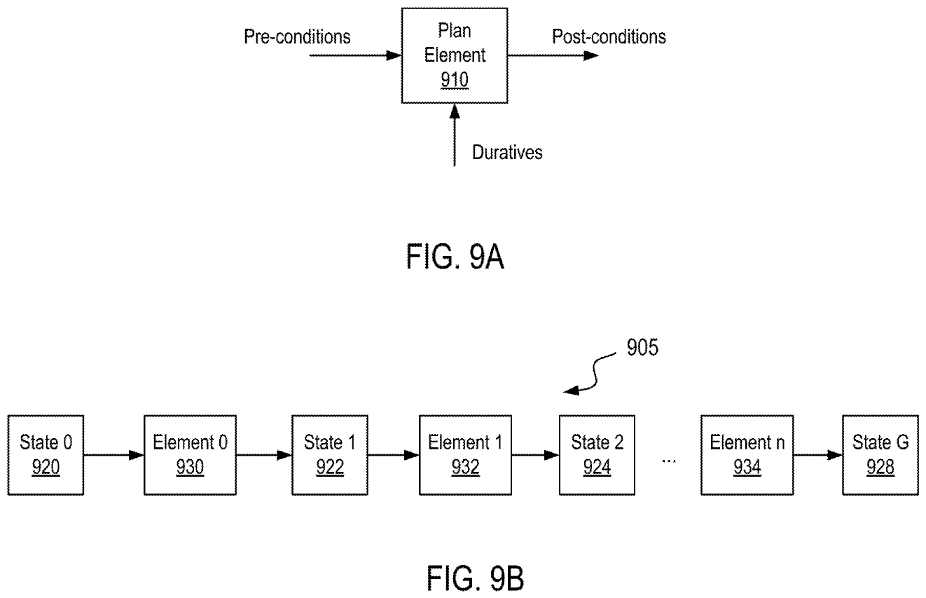

FIG. 9A illustrates an example of a plan element 910. Plan element 910 may change some properties of the internal state of the digital persona and/or the external state of external environments, while maintaining some properties of the internal states and/or external states. Plan element 910 may only be applied if certain properties of the internal and/or external states are true, which may be referred to as the pre-conditions of plan element 910. The expected changes to the properties of the internal and/or external states after plan element 910 is applied may be referred to as the post-conditions of plan element 910. A property of the internal or external state that needs to be maintained while a plan element is applied may be referred to as a durative. Examples of plan element 910 may include speaking, outputting text, actuating a robotic arm, sending an electronic message to a computer system, or another action that may affect the external environment. Examples of plan element 910 may also include a behavior or goal described above. As also described above, a plan element may also include an operator. However, unlike the action, behavior, and goal, an operator may not have the pre-conditions, post-conditions, and duratives associated with it.

FIG. 9B illustrates an example of a plan 905 that includes a set of plan elements determined by a planner to achieve a target state of the digital persona according to certain embodiments. The set of plan elements may include element 0 (930), element 1 (932), . . . , and element n (934). The target state to achieve by plan 905 is state G (928). The initial state for applying plan 905 is state 0 (920), which needs to be true before the set of plan elements may be applied. State 0 (920) may be the pre-conditions for element 0 (930), while state 1 (922) may be the post-conditions of element 0 (930). State 1 (922) may also be the pre-conditions for element 1 (932), while state 2 (924) may be the post-conditions of element 1 (932). The last plan element n (934) may have post-conditions of state G (928), which is also the target state to be achieved by plan 905. It is noted that even though the example of plan 905 illustrated in FIG. 9B is a linear plan, in other examples, a plan may not be a linear plan. For example, a plan may include some branches that may be executed in parallel or sequentially, may include some loops, or may include some more complex structures.

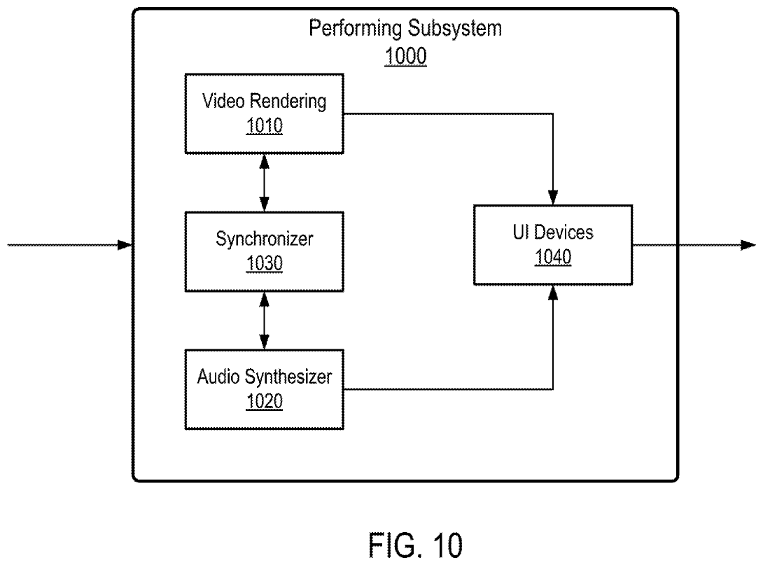

At 550, a performing subsystem (e.g., performing subsystem 230) of the digital persona system may perform the plan elements in the plan determined at 540 using information stored in the knowledge database. For example, the performing subsystem may use input and output devices to engage in interactions with real people, make a speech, or make a body movement. An example of a performing subsystem is described in detail below with respect to FIG. 10.

At 560, one or more (physical or virtual) sensors of the digital persona system my detect feedback from the external environment. The feedback may be processed as described above with respect to, for example, FIG. 2. Knowledge may be extracted from the feedback and provided to the digital persona system to update the knowledge database and determine if the desire determined at 510 has been achieved. As described above with respect to 510, the digital persona system may determine whether a desire has been achieved by determining the intensity value for the desire based on the changes in the internal and/or external states. If the desire has been achieved, the digital persona system may proceed to achieve another desire, such as a desire with a high intensity value. If the desire has not been achieved, the digital persona system may perform the operations in cognitive chain 500 one or more times until the desire is achieved.

The operations of the desire layer, the intent layer, the goal-setting layer, the planning layer, the action layer, and the sensors may be supported by knowledge database 590. Knowledge database 560 may keep track of facts and data that may be compared against outputs of intents or goal-based conditions, data used to compute the intensity of the desire, data used to parameterize the actions to be performed, and the like.

In one example of an application of cognitive chain 500, a desire determined at 510 may be to make people happy. An intent identified at 520 may be to make people laugh. At 530, one goal that matches the outcome of the intent may be telling a joke. A plan determined by planners at 540 may include selecting an appropriate joke from the knowledge database. The digital persona may then tell the joke in a manner consistent with the behavior of the subject impersonated by the digital persona at 550. The feedback may indicate whether the audience laughs or not. If the feedback indicates that the audience has laughed, the desire may have been achieved. Otherwise, a different joke may be selected and may be presented to the audience in a similar or different manner.

FIG. 10 illustrates an example of a performing subsystem 1000 for implementing a digital persona of a subject according to certain embodiments. Performing subsystem 1000 may be a specific implementation of performing subsystem 230. In the illustrated example, performing subsystem 1000 may include a video rendering subsystem 1010, an audio synthesizer 1020, a synchronizer 1030, and user interface devices 1040. Performing subsystem 1000 may convey the information determined by cognitive subsystem 220 in a manner that is consistent with the behavior of the subject represented by the digital persona.

For example, audio synthesizer 1020 may use a trained machine learning model configured to synthesize the audio output based on the content of the information to convey, such as a text message. Audio synthesizer 1020 may be able to synthesize the audio output based on the age, tone, emotion, volume, setting (e.g., public speech or private conversation), and the like of the digital persona in a particular context. In some embodiments, audio synthesizer 1020 may also be able to synthesize the singing of the digital persona. Audio synthesizer 1020 may be trained using audio recordings of speeches or conversations by the subject. For example, the transcripts of the audio recordings may be converted from audio waves or may be obtained otherwise together with the audio recordings. The neural network model may then be trained using the audio recordings and the corresponding transcripts such that the neural network model may generate audio waves based on the textual content of the information to be conveyed by the digital persona of the subject. In some embodiments, audio synthesizer 1020 may generate audio waves based on some scripts or text by assembling sections of audio wave that correspond to sections of the scripts or text.

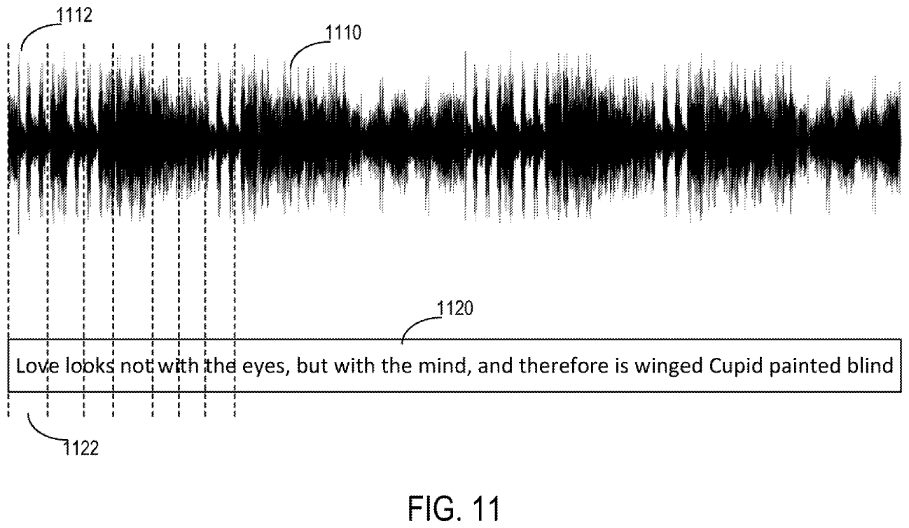

FIG. 11 illustrates an example of an audio wave 1110 from an audio recording of a speech or conversation of a subject and the corresponding transcript 1120 for training an audio synthesizer (e.g., audio synthesizer 1020) according to certain embodiments. Audio wave 1110 from the audio recording and corresponding transcript 1120 may be split into small sections. Each section 1112 of audio wave 1110 may have a duration of, for example, one-eighth of a second, a quarter of a second, or a variable duration. The corresponding transcript 1120 may also be split in a similar manner, where each section 1122 of transcript 1120 may include one or more letters that correspond to a respective section 1112 of audio wave 1110 For example, a section 1122 of transcript 1120 may include a part of a word, a word, parts of two words, a phrase, and the like. Sections 1112 in audio wave 1110 and corresponding sections 1122 in transcript 1120 may be used as training samples to train a neural network-based audio synthesis model.

Video rendering subsystem 1010 may approximate the appearance and bodily movements of the subject, such as facial expressions, eye movements, motions, etc. of the subject. In some embodiments, 3-D or 2-D meshes may be built for the subject based on, for example, images or videos of the subject or measurement results of depth sensors. In some embodiments, a photogrammetry technique may be used to build 3-D meshes that model the head or the whole body of the subject, where hundreds, thousands, or millions of images of the subject's body may be taken at various angles in the 3-D space over a period of time, during which the subject may make various movements or take various action. For example, the subject may read a book, make a speech, smile, or perform another specific task (e.g., dance or play with a ball). The 3-D meshes may include a set of motifs, such as triangles or other polygons, or a set of feature points. The shapes of the motifs or the locations of the feature points may be different when the subject is in different poses or perform different acts. For example, the shapes of the motifs or the locations of the feature points of a 3-D model for a subject's face may be different when the subject makes different facial expressions or is in different moods. Algorithms or models may be developed to transform the motifs in the 3-D meshes or to move the feature points in a 3-D model to approximate the facial, limb, torso, or other body movements of the subject in different situations.

In some embodiments, video rendering subsystem 1010 may determine appropriate face expressions and body movements of the digital persona, and use the algorithms to transform the 3-D models of the digital persona, such as deforming the motifs of a 3-D mesh model or changing the coordinates of feature points in a 3-D model. For example, video rendering subsystem 1010 may determine the facial expressions associated with the message to convey, such as the corresponding eye movements, lip movements, facial muscle movements, hair movements, pore movements, arm movements, and the like. Video rendering subsystem 1010 may then determine how the feature points or the motifs of the 3-D model should be changed to reflect these movements.

Synchronizer 1030 may coordinate the operations of video rendering subsystem 1010 and audio synthesizer 1020, such that the video outputs from video rendering subsystem 1010 and the audio outputs from audio synthesizer 1020 can be synchronously delivered to the audience by UI devices 1040. UI devices 1040 may include one or more of a speaker, a display, a projector, a virtual reality device, an augmented reality device, a controller for a robot, and the like.

As described above, during the interactions, the digital persona may be updated to include new concepts, new context, new events, new beliefs, new performances, or new relations. The digital persona may be aware of itself and other people that have a relationship with the subject represented by the digital persona, and thus can engage in more personal interactions with other people. The digital persona may have cognition, memories, and emotions, and may have a persistent presence. As such, the digital persona may remember, learn, and comprehend context, and thus may grow like a human.

In some embodiments, the digital persona system can be used to implement a bot (also referred to as a chatbot, chatterbot, or talkbot) that can perform conversations with end users by responding to natural-language messages (e.g., questions or comments) through a messaging application. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction). In some embodiments, a bot implemented using the digital persona system described herein may not need to follow a specific script or a specific conversation flow that includes multiple states.

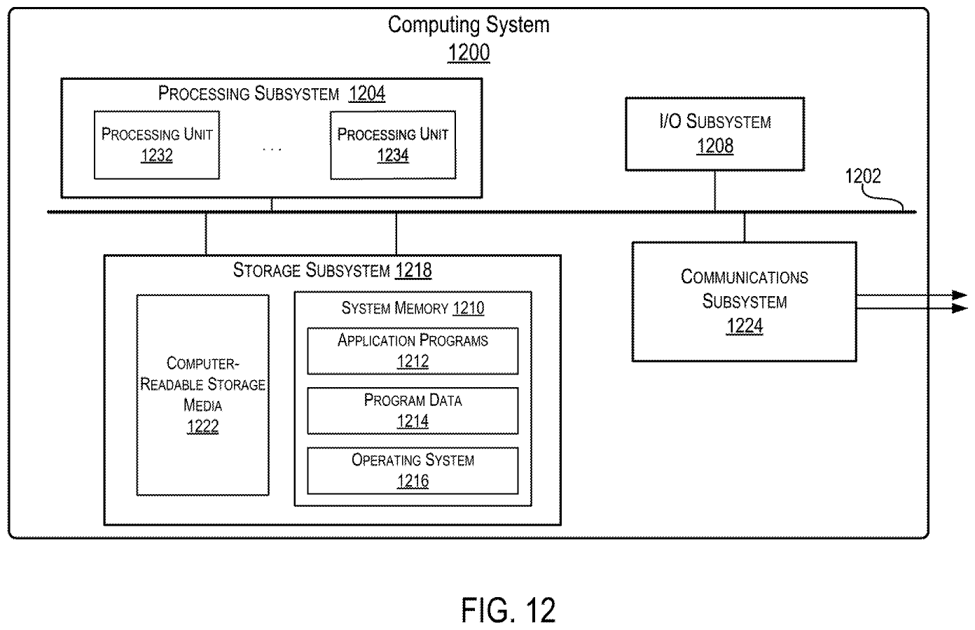

FIG. 12 illustrates an example of computing system 1200. In some examples, computing system 1200 may be used to implement any of the computing system described above, such as digital persona system 200 or performing subsystem 800, or any machine learning models or mathematical models described above. As shown in FIG. 12, computing system 1200 includes various subsystems including a processing subsystem 1204 that communicates with a number of other subsystems via a bus subsystem 1202. These other subsystems may include an optional processing acceleration unit (not shown), an I/O subsystem 1208, a storage subsystem 1218, and a communications subsystem 1224. Storage subsystem 1218 may include non-transitory computer-readable storage media including storage media 1222 and a system memory 1210.

Bus subsystem 1202 provides a mechanism for letting the various components and subsystems of computing system 1200 communicate with each other as intended. Although bus subsystem 1202 is shown schematically as a single bus, alternative examples of the bus subsystem may utilize multiple buses. Bus subsystem 1202 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 1204 controls the operation of computing system 1200 and may comprise one or more processors, application specific integrated circuits (ASICs), or field programmable gate arrays (FPGAs). The processors may include single core or multicore processors. The processing resources of computing system 1200 may be organized into one or more processing units 1232, 1234, etc. A processing unit may include one or more processors, one or more cores from the same or different processors, a combination of cores and processors, or other combinations of cores and processors. In some examples, processing subsystem 1204 may include one or more special purpose co-processors such as graphics processors, digital signal processors (DSPs), or the like. In some examples, some or all of the processing units of processing subsystem 1204 may be implemented using customized circuits, such as application specific integrated circuits (ASICs), or field programmable gate arrays (FPGAs).

In some examples, the processing units in processing subsystem 1204 may execute instructions stored in system memory 1210 or on computer readable storage media 1222. In various examples, the processing units may execute a variety of programs or code instructions and may maintain multiple concurrently executing programs or processes. At any given time, some or all of the program code to be executed may be resident in system memory 1210 and/or on computer-readable storage media 1222 including potentially on one or more storage devices. Through suitable programming, processing subsystem 1204 may provide various functionalities described above. In instances where computing system 1200 is executing one or more virtual machines, one or more processing units may be allocated to each virtual machine. In some embodiments, system memory 1210 may be distributed across different cloud storage or other storage devices. In some embodiments, system memory 1210 may be partially available, where only portions of system memory 1210 that store data relevant to current processing and interaction must be made available to processing subsystem 1204, while other latent memory may be distributed across local, remote, or cloud storage or may be in disconnected storage devices.

In certain examples, a processing acceleration unit may optionally be provided for performing customized processing or for off-loading some of the processing performed by processing subsystem 1204 so as to accelerate the overall processing performed by computing system 1200.

I/O subsystem 1208 may include devices and mechanisms for inputting information to computing system 1200 and/or for outputting information from or via computing system 1200. In general, use of the term input device is intended to include all possible types of devices and mechanisms for inputting information to computing system 1200. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computing system 1200 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD), light emitting diode display (LED), or plasma display, a projection device, a holographic display, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1218 provides a repository or data store for storing information and data that is used by computing system 1200. Storage subsystem 1218 provides a tangible non-transitory computer-readable storage medium for storing the basic programming and data constructs that provide the functionality of some examples. Storage subsystem 1218 may store software (e.g., programs, code modules, instructions) that when executed by processing subsystem 1204 provides the functionality described above. The software may be executed by one or more processing units of processing subsystem 1204. Storage subsystem 1218 may also provide authentication in accordance with the teachings of this disclosure.

Storage subsystem 1218 may include one or more non-transitory memory devices, including volatile and non-volatile memory devices. As shown in FIG. 12, storage subsystem 1218 includes a system memory 1210 and a computer-readable storage media 1222. System memory 1210 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computing system 1200, such as during start-up, may typically be stored in the ROM. The RAM typically contains data and/or program modules that are presently being operated and executed by processing subsystem 1204. In some implementations, system memory 1210 may include multiple different types of memory, such as static random access memory (SRAM), dynamic random access memory (DRAM), and the like.

By way of example, and not limitation, as depicted in FIG. 12, system memory 1210 may load application programs 1212 that are being executed, which may include various applications such as Web browsers, mid-tier applications, relational database management systems (RDBMS), etc., program data 1214, and an operating system 1216. By way of example, operating system 1216 may include various versions of Microsoft Windows®, Apple OS X®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 1222 may store programming and data constructs that provide the functionality of some examples. Computer-readable storage media 1222 may provide storage of computer-readable instructions, data structures, program modules, and other data for computing system 1200. Software (programs, code modules, instructions) that, when executed by processing subsystem 1204, provides the functionality described above, may be stored in storage subsystem 1218. By way of example, computer-readable storage media 1222 may include non-volatile memory such as a hard disk drive, a magnetic disk drive, an optical disk drive such as a CD ROM, DVD, a Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 1218 may also include a computer-readable storage media reader (not shown) that may further be connected to computer-readable storage media 1222. The computer-readable storage media reader may receive and be configured to read data from a memory device such as a disk, a flash drive, etc.

In certain examples, computing system 1200 may support virtualization technologies, including, but not limited to, virtualization of processing and memory resources. For example, computing system 1200 may provide support for executing one or more virtual machines. In certain examples, computing system 1200 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computing system 1200. Accordingly, multiple operating systems may potentially be run concurrently by computing system 1200.

Communications subsystem 1224 provides an interface to other computer systems and networks. Communications subsystem 1224 serves as an interface for receiving data from and transmitting data to other systems from computing system 1200. For example, communications subsystem 1224 may enable computing system 1200 to establish a communication channel to one or more client devices via the Internet for receiving and sending information from and to the client devices. For example, when computing system 1200 is used to implement bot system 120 depicted in FIG. 1, the communication subsystem may be used to communicate with an application system and also a system executing a storage virtual machine selected for an application.

Communication subsystem 1224 may support both wired and/or wireless communication protocols. In certain examples, communications subsystem 1224 may include radio frequency (RF) transceiver components for accessing wireless voice and/or data networks (e.g., using cellular telephone technology, advanced data network technology, such as 3G, 4G, EDGE (enhanced data rates for global evolution), or 5G, WiFi (IEEE 802.XX family standards), or other mobile communication technologies, or any combination thereof), global positioning system (GPS) receiver components, and/or other components. In some examples, communications subsystem 1224 may provide wired network connectivity (e.g., Ethernet) in addition to or instead of a wireless interface.

Communication subsystem 1224 may receive and transmit data in various forms. In some examples, in addition to other forms, communications subsystem 1224 may receive input communications in the form of structured and/or unstructured data feeds 1226, event streams 1228, event updates 1230, and the like. For example, communications subsystem 1224 may be configured to receive (or send) data feeds 1226 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 1224 may be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1224 may also be configured to communicate data from computing system 1200 to other computer systems or networks. The data may be communicated in various different forms such as structured and/or unstructured data feeds 1226, event streams 1228, event updates 1230, and the like to one or more databases that may be in communication with one or more streaming data source computers coupled to computing system 1200.

Computing system 1200 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computing system 1200 depicted in FIG. 12 is intended only as a specific example. Many other configurations having more or fewer components than the system depicted in FIG. 12 are possible. Based on the disclosure and teachings provided herein, a person of ordinary skill in the art will appreciate other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable storage medium or computer-readable storage medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, examples may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some examples, the systems may be configured as a distributed system where one or more components of the system are distributed across one or more networks in a cloud computing system.

Where components are described as being “configured to” perform certain operations, such configuration may be accomplished, for example, by designing electronic circuits or other hardware to perform the operation, by programming or controlling electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A system for determining autonomous actions of a digital persona for a subject, the system comprising:
a desire subsystem configured to identify a desire of the digital persona based upon a priority value of the desire determined using a state associated with the digital persona;
an intent subsystem configured to select, from a set of intents and based upon outcomes associated with the set of intents, a subset of intents with outcomes that are determined to reduce the priority value of the desire;
a goal-setting subsystem configured to map the subset of intents to one or more goals with outcomes matching the outcomes of the subset of intents;
a planning subsystem configured to determine a set of plan elements for achieving the one or more goals;
an action subsystem configured to initiate or perform the set of plan elements; and
a sensory subsystem configured to receive feedback and update the state associated with the digital persona.

2. The system of claim 1, further comprising a memory subsystem, the memory subsystem storing at least one of:
the state associated with the digital persona;
the set of intents and the outcomes associated with the set of intents;
the one or more goals and the outcomes of the one or more goals;
data used to determine the priority value of the desire;
a plan including the set of plan elements and data used to perform the set of plan elements;
data associated with the subject; or
general or expert knowledge not specific to the subject.

3. The system of claim 1, wherein the desire subsystem includes a set of functions configured to calculate priority values of a plurality of desires based upon the state associated with the digital persona.

4. The system of claim 1, wherein the state associated with the digital persona includes at least one of an internal state of the digital persona or an external state of an external environment of the digital persona.

5. The system of claim 4, wherein the external state includes an external stimulus detected by the sensory subsystem.

6. The system of claim 4, wherein the set of plan elements includes at least one of:
an operator configured to change the internal state but not the external state;
an action for conveying a visual, audio, text, or electronic message to the external environment of the digital persona;
a goal; or
a behavior including at least one of an operator, an action, or a goal.

7. The system of claim 6, wherein each plan element in the action, goal, and behavior is associated with at least one of:
a pre-condition to be met before performing the plan element;
a post-condition resultant from the performing the plan element; or
a condition to be maintained during the performing the plan element.

8. The system of claim 1, wherein the intent subsystem includes a machine-learning model configured to select the subset of intents based upon the outcomes associated with the set of intents and effects of the outcomes associated with the set of intents on the state of the digital persona.

9. The system of claim 1, wherein each intent in the set of intents is associated with one or more outcomes.

10. The system of claim 1, wherein each goal of the one or more goals includes a method for achieving one or more outcomes.

11. The system of claim 1, wherein the planning subsystem is configured to determine data used to perform the set of plan elements.

12. A non-transitory computer-readable storage medium storing computer-executable instructions that, when executed by one or more processors of a computing system, cause the one or more processors to perform operations including:
identifying a desire of a digital persona for a subject based upon a priority value of the desire determined using a state associated with the digital persona;
selecting, from a set of intents and based upon outcomes associated with the set of intents, a subset of intents with outcomes that are determined to reduce the priority value of the desire;
mapping the subset of intents to one or more goals with outcomes matching the outcomes of the subset of intents;
determining a set of plan elements for achieving the one or more goals;
initiating or performing the set of plan elements;
receiving feedback; and
updating the state associated with the digital persona.

13. The non-transitory computer-readable storage medium of claim 12, wherein determining the set of plan elements includes determining data used to perform the set of plan elements.

14. The non-transitory computer-readable storage medium of claim 12, wherein the set of plan elements includes at least one of:
an operator for changing an internal state but not an external state of the digital persona;
an action for conveying a visual, audio, text, or electronic message to the external environment of the digital persona;
a goal; or
a behavior including at least one of an operator, an action, or a goal.

15. The non-transitory computer-readable storage medium of claim 14, wherein each plan element in the action, goal, and behavior is associated with at least one of:
a pre-condition to be met before performing the plan element;
a post-condition resultant from the performing the plan element; or
a condition to be maintained during the performing the plan element.

16. A computer system comprising:
one or more processors; and
a non-transitory computer readable storage medium containing instructions that, when executed by the one or more processors, cause the one or more processors to perform operations including:
identifying a desire of a digital persona for a subject based upon a priority value of the desire determined using a state associated with the digital persona;
selecting, from a set of intents and based upon outcomes associated with the set of intents, a subset of intents with outcomes that are determined to reduce the priority value of the desire;
mapping the subset of intents to one or more goals with outcomes matching the outcomes of the subset of intents;
determining a set of plan elements for achieving the one or more goals;
initiating or performing the set of plan elements;
receiving feedback; and
updating the state associated with the digital persona.

17. The computer system of claim 16, further comprising a memory subsystem storing at least one of:
the state associated with the digital persona;
the set of intents and the outcomes associated with the set of intents;
the one or more goals and the outcomes of the one or more goals;
data used to determine the priority value of the desire;
a plan including the set of plan elements and data used to perform the set of plan elements;
data associated with the subject; or
general or expert knowledge not specific to the subject.

18. The computer system of claim 16, wherein the set of plan elements includes at least one of:
an operator configured to change an internal state of the digital persona;
an action for conveying a visual, audio, text, or electronic message to the external environment of the digital persona;
a goal; or
a behavior including at least one of an operator, an action, or a goal.

19. The computer system of claim 18, wherein each plan element in the action, goal, and behavior is associated with at least one of:
a pre-condition to be met before performing the plan element;
a post-condition resultant from the performing the plan element; or
a condition to be maintained during the performing the plan element.

20. The computer system of claim 16, wherein:
each intent in the set of intents is associated with one or more outcomes; and
each goal of the one or more goals includes a method for achieving one or more outcomes.
